(19) United States
(12) Patent Application Publication
(10) Pub. No.: US 2003/0070751 A1
(43) Pub. Date: Apr. 17, 2003

(54) Method of manufacture for fluid handling polymeric barrier tube

(76) Inventors: Kevin Bergevin, Kingston (CA); Greg A. Campbell, Kingston (CA); Kenneth Earl Stevens, Kingston (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/255,245

(22) Filed: Sep. 26, 2002

Related U.S. Application Data
(60) Provisional application No. 60/325,224, filed on Sep. 27, 2001.

(51) Int. Cl. B32B 31/00

(52) U.S. Cl. 156/297; 428/188

(57) ABSTRACT

A method for making fluid handling structures by arranging and positioning polymeric tubes spaced on a sheet of foil made of metal, with plastic on at least the side facing the tubes, adding another such foil to bond on the other side of the tubes, and heating the resulting assembly, either before or after adding the second layer of foil, to bond it into a structure with spaced apart tubes encapsulated in foil on both sides.

### CROSS REFERENCE TO RELATED APPLICATIONS

This application claims the benefit of U.S. Provisional Application No. 60/325,224 filed Sep. 27, 2001.

### FIELD OF THE INVENTION

The invention relates to a method for the manufacture of plastic tube fluid handling means for use in fuel lines, refrigerator hose, in-floor heating pipe, solar hot water heating systems and the like.

### BACKGROUND OF THE INVENTION

Among the challenges in making plastic fluid handling devices is the need for improved barrier properties. Among the highest demands for low permeability are fuel lines and refrigeration hose applications. In the former, legislation in many areas requires structures with lower permeability to volatiles in (motor) fuel relative to incumbents such as nylon 11 or 12 or these in combination with fluoropolymers such as polytetrafluoroethylene (PTFE) or polyvinylidene fluoride (PVDF). For the latter, there is a need to keep the refrigerant in and both water vapor or moisture and air out under working conditions of high pressure.

It has been recognized that metal layers will provide impermeability to polymeric tubes for use in subfloor heating and other applications. However, structures for obtaining good impermeability for practical use in these systems from the combination of metal and plastic or polyamide and aluminum are not available or are costly to produce. Some have suggested applying metal after assembling a structure, such as by sputtering. However, sputtering, while it may give a complete coating, does not provide the impermeability needed. Others wrap a layer of foil around a preformed tube, either longitudinally or helically. The foil can be lapped and folded over at the seam to provide a complete seal (as described for example in EP A 0 024 220 and U.S. Pat. No. 4,370,186) or can be welded for example by means of a laser (as described in U.S. Pat. No. 5,991,485). Usually, the foil is overcoated with additional layer(s) of plastic. Tubing made using these processes is costly, as the processes suffer from relatively low productivity.

U.S. Pat. No. 4,069,811 discloses in FIG. 7 a heat exchanger element with spaced-apart copper or plastic tubes surrounded by and encased in spot-welded sheets of a rigid, preferably black, metal absorber plate. U.S. Pat. No. 5,469,915 shows tubes of plastic or metal encased in and held apart by plastic sheets. European Patent Publication 864,823 A2 discloses tubes for solar heat exchangers made of an elastomer or plastic inner layer, a stiffener layer of thermally conductive metal such as aluminum in the form of a mesh or a helical layer, and optionally an outer layer of the same elastomer or plastic. The inner polymer layer can be 0.1-2.5 mm (0.004 inches to 0.1 inches) thick, preferably 0.1-0.3 mm (0.004 inches to 0.012 inches), and the stiffener can be 0.1-2 mm (0.004 inches to 0.079 inches) thick. However, although the metal stiffener may absorb heat well, it is taught to be used as a mesh or helical layer, so it would not provide any degree of impermeability.

U.S. Pat. No. 3,648,768 shows making a web of plastic with parallel tubes spaced apart in the web. It says nothing about barrier layers or using metal in the webs.

### SUMMARY OF THE INVENTION

The invention provides a method for making a fluid handling apparatus comprising at least one polymeric tube, said tube surrounded by and sealed to a laminated foil, said foil having two faces, one facing toward the tube, and the other facing away from the tube, said foil comprising at least one layer of metal with polymer layers on at least the side facing the tube,

said tube having an inner diameter in the range of 0.550 mm and a wall thickness in the range of 0.1-1.0 mm,

said foil having a total thickness in the range of 0.05-0.25 mm and a total metal thickness in the range of 0.002-0.1 mm,

said method comprising the steps of

contacting the tubes on one side with a first foil, contacting the tubes on the other side of the tubes with a second foil,

heating the tubes with the foil on at least one side to adhere the foil to the tubes before or after contacting the tubes with said second foil, conforming said first and second foils to the tubes to essentially eliminate air bubbles or gaps, and optionally completing the heat sealing of both the first and second foils to the tubes with a second heating step.

Preferably, the thickness of the foil is in the range of 0.07-0.2 mm (and most preferably 0.1-0.15 mm) and the thickness of the metal is in the range of 0.005-0.02 mm (and most preferably 0.005-0.01 mm). Moreover the inner diameter of the tube is preferably in the range of 1-25 mm and the wall thickness of the tube in the range of 0.1-0.5 mm.

Where more than one tube is used, such a structure is herein referred to as a barrier ribbon. Single-tube and multiple-tube structures are both within the invention.

### BRIEF DESCRIPTION OF THE DRAWINGS

FIG. 1 is an illustration of a multiple tube structure of the invention in perspective.

FIG. 2 is an illustration of a single tube structure of the invention in perspective.

FIG. 3 is a detailed end view of a cross section of a single tube structure of the invention.

FIG. 4(a) is a side view of apparatus used in the method of manufacture of polymeric barrier tubes according to the invention.

FIG. 4(b) is a cross-sectional view of a hot plate and jig used in FIG. 4(a) and product formed therefrom.

FIG. 4(c) is a cross-sectional view of a product of FIG. 4(a), shown prior to its full conversion to final product.

FIG. 5(a) is a side view of further apparatus used in the method of manufacture of polymeric barrier tubes according to the invention.

FIG. 5(b) is a cross-sectional view of a die plate and weight configuration used in FIG. 5(a).

FIG. 5(c) is a plan view of a die plate used in FIGS. 5(a) and 5(b).

### DETAILED DESCRIPTION OF THE INVENTION

Tubing and hose requirements for a number of industrial applications include very high barrier to water, or air/oxygen or contained materials such as refrigerants. For example, when attempting to design a refrigerant-capable hose from polymeric tubing, a number of factors must be considered:

i) The refrigerant must be retained inside the tubing structure for a long time such as for many years, with minimal losses.

ii) Moisture and air must be prevented from permeating into the tubing. Air is non-condensable and would diminish the performance of the heat exchanger. Moisture reacts with refrigerants such as hydrofluorocarbons (HFC's) and hydrochlorofluorocarbons (HCFC's) and the products of this reaction can lead to failure of the system due to corrosion and sludge.

iii) Many refrigerants operate under high pressures (several hundred psig) and the tubing must be capable of withstanding 3-5 times the normal system operating pressures.

Unfortunately, the best polymeric barrier materials available may at times be insufficient to keep moisture and air entry below an acceptable level.

Reference is made throughout the case to tubes (either singular as “tube” or plural as “tubes” or even both as “tube(s)”), “tubing” and the like, and is to be understood that depending on the application of interest one tube and/or a plurality of tubes may be selected in each such instance. Therefore throughout the case these terms are often used interchangeably, and it will be apparent to the reader whether the singular, plural or both will apply.

Moreover, those having skill in the art to which the invention pertains will recognize that throughout the description of the present invention the terms “foil”, “laminated foil”, “film”, and the like are intended to convey the same meaning.

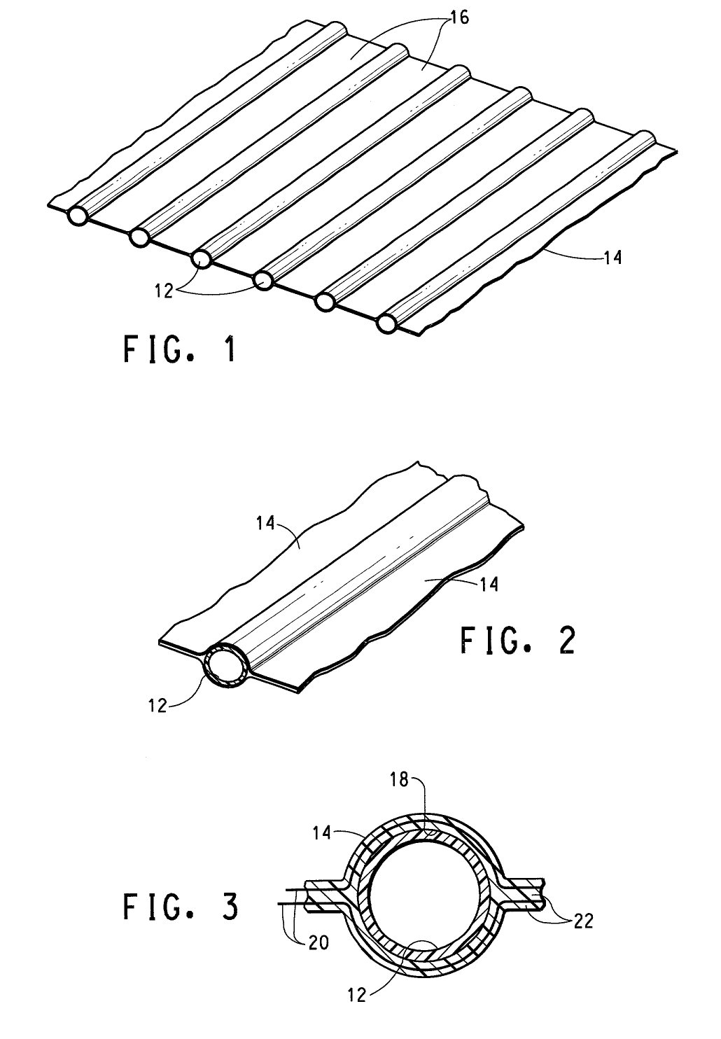

Having reference to FIGS. 1 and 2, the present invention contemplates a composite structure in which one or more polymeric tubes 12 is completely surrounded by a film 14 containing a metal layer. When the invention comprises multiple tubes, as in FIG. 1, the tubes are connected by a webbing 16 of thermally conductive film between and beside each tube 12.

As shown in FIG. 3, the film 14 containing a metal layer 20 is wrapped in conformal fashion around the tube(s) 12 and is preferably bonded to the outer surface 18 of the tube(s) 12 where it contacts the tube(s) 12 or to itself in the areas adjacent to the tubes 12. It is desirable to produce a tight wrap around the tube(s) 12, with no significant free volume between the outside surface 18 of the tube(s) 12 and the inside surface of the film 14. In this manner there are no significant air gaps or voids between the foil and the tubes. In particular, when the film 14 containing a metal layer 20 consists of a laminate of a metal (e.g. aluminum), such as aluminum with polymeric layers 22, then the metal layer 20 provides a suitable barrier, capable of preventing excessive moisture and air entry. Such foil laminates are widely available and are of relatively low cost, compared with other materials of similar barrier properties. Furthermore, the location of the high barrier layer outside of, and surrounding the tubing, as shown in FIGS. 1, 2 and 3, serves to keep the tubing relatively dry. This is significant when the tubing is a moisture sensitive material such as a polyamide. The burst pressure of dry polyamide tubing is much higher than it is for polyamide exposed to environmental humidity. This feature allows the tubing to be designed with a larger tube diameter.

The combination of all of these features results in a relatively simple low cost material (structure of one or more polyamide tubes with outer bonding layer inside a foil laminate with inner bonding layer) which could be produced in a low cost process and which would be fully functional as fuel lines, refrigerator hose, in-floor heating pipe or the like. Solar collector panels could be fabricated from a wide sheet containing multiple tubes held in parallel. In as much as polyamide is a useful polymeric material, there are any number of structural arrangements incorporating polyamides that are also preferred. For example, in one such configuration the polymer of at least the layer of the foil facing away from the tube is polyamide. In another, the polymer of the tube and at least one layer of the polymer of the foil are both polyamide.

A preferred method of the invention involves making a structure having multiple tubes arranged in parallel, with the tubes held in place by, surrounded by and sealed to the laminated foil. In addition, if more than one tube is produced in parallel manner, with adequate spacing between tubes, the laminate could be slit as needed (i.e. at the foil between the tubes), into individual tubes or smaller groupings of tubes.

Corrosion of the metallic layer can be minimized with the inclusion of a polymeric layer outside of the metallic layer, i.e. the metallic layer is sandwiched. Alternatively, for more corrosive applications, a more corrosion resistant metal such as nickel or tin may be used as the metallic layer.

For some applications, it may be desirable for the film containing a metal layer to be quite flexible. Fuel lines, refrigerator hose, in-floor heating pipe, solar collector panels and the like made from barrier ribbon are lighter in weight than existing all-metal structures.

The tube spacing within the ribbon can be varied, and can either be uniform or can vary across the ribbon. Tubes can be circular in cross-section or can be elliptical or of other non-circular shape. The tubing may be extruded as elliptical in shape or may be extruded as circular in shape and then made elliptical in the process of making the ribbon.

A number of different polymers could be chosen for the tubing material, but selection depends on the needs for specific applications and should be based on: service temperature, chemical resistance and pressure. Tube diameter and wall thickness are sized to handle the pressure of respective applications.

It is readily appreciated that multiple layers of polymer may be incorporated in the foil. In another configuration, the foil has no layer of polymer on the side facing away from the tubes. In one preferred method polyolefin is used as a layer on the side facing the tubes and a layer of polyamide is applied on the side of the foil facing away from the tubes. One may optionally co-extrude layers on the exterior of tubing, or add layers on one side of the film material to enhance bonding. It is important in some cases to bond the film layer to the tubing and to the opposing film layer in order to prevent “pocketing” of refrigerant between the tubing and the foil laminate.

Metal surrounds the tubing except in small areas at nodes and edges and this provides a significant improvement in barrier to permeation of refrigerant, moisture and air. Within the foil laminate, more than one layer of metal could be used or the metal layer thickness could be varied to achieve desired levels of barrier.

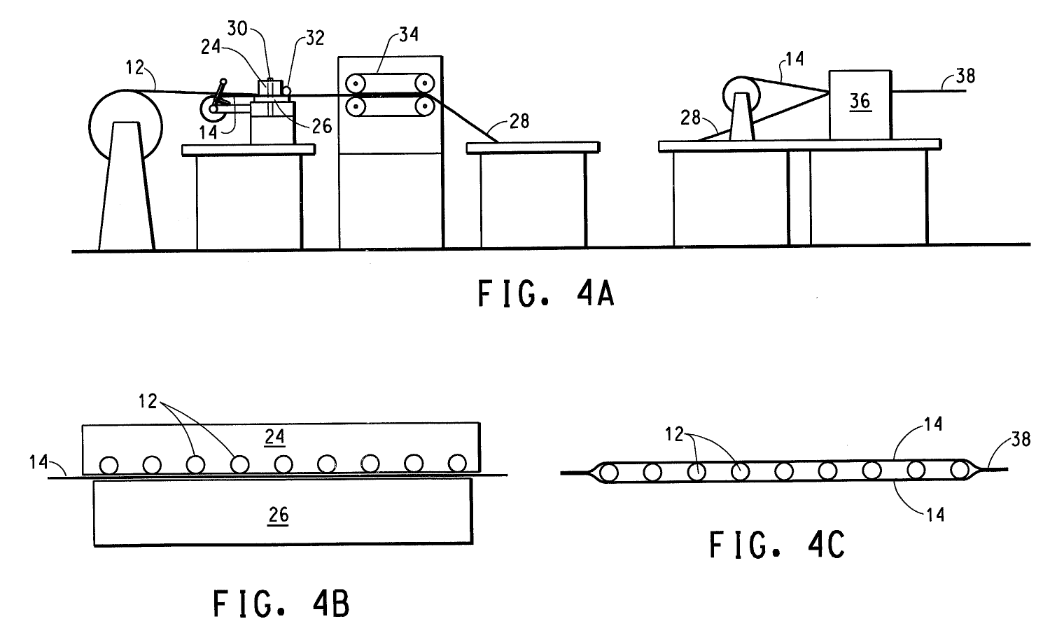

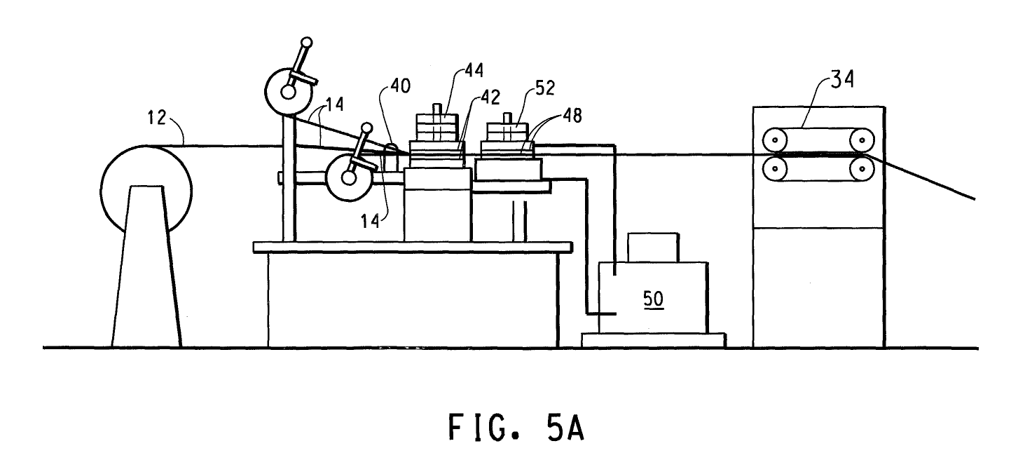

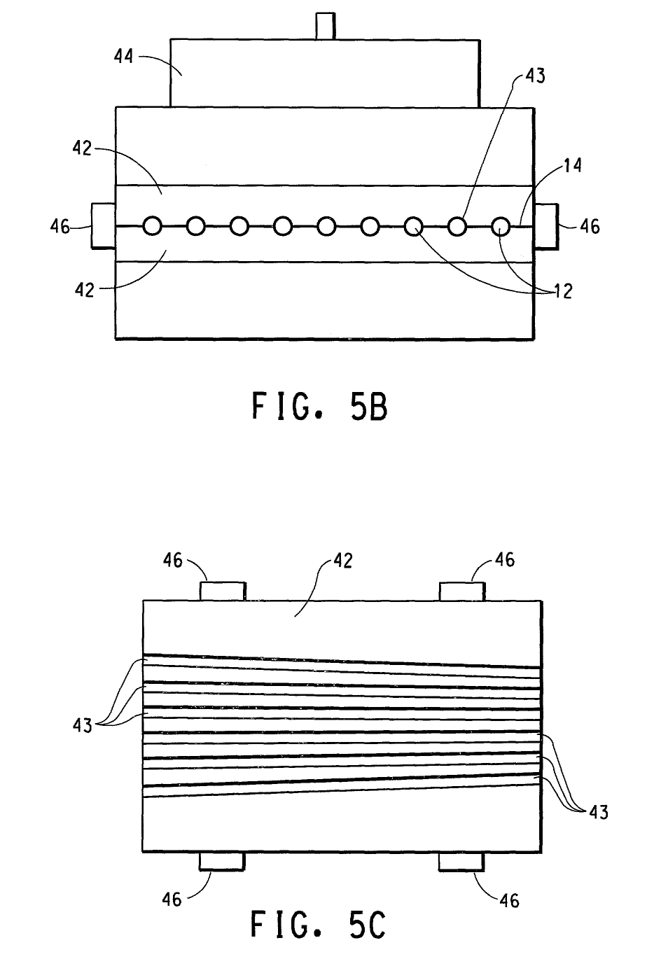

Having reference to FIGS. 4(a) and 4(b) and 4(c) and 5(a) and 5(b) and 5(c), the method for manufacture of fluid handling polymeric barrier tubes as described above can be described as follows.

In FIG. 4(a) tubes 12 are pulled through jig 24 which rests on top of hot plate 26. Simultaneously, and at the same speed, film 14 is pulled between the tubes 12 and the hot plate 26. The surface of the tubes 12 contacts the surface of the film 14 on the hot plate 26, as shown in more detail in FIG. 4(b). Heat from the hot plate bonds the tubes 12 to the film 14 to produce the tack-welded structure 28. Pressure for bonding the tubes 12 to the film 14 is supplied by the weight 30 and lay-on roller 32. The belt puller 34 provides the motive power to pull the materials through this first step. In the second step, the tack-welded structure 28 is fed into rotary edge sealer 36 along with a second film layer 14. The rotary edge sealer 36 heat-seals the edges to produce ribbon sleeve 38, which is shown in more detail in FIG. 4(c). The ribbon sleeve 38 is then placed in a vacuum sealer in the third step (not shown) which removes the air from between the tubes and the films and seals the end, as is commonly practiced in the making of vacuum pouches. In the fourth step (not shown) the ribbon sleeve is placed in a hot oven and the bonding is completed.

The productivity may be improved by increasing the width of the laminated structure by laminating several tubes at one time, held in parallel by a block of PTFE containing several slots, and then slitting the structure to between tubes in the machine direction to produce individual tubes or desired widths of several joined tubes needed for the particular application.

An alternative apparatus is shown in(FIGURE 5(a). Tubes 12 are pulled together with two films 14 through guides 40 and then between two matching heated die plates 42. The heated die plates have semi-circular grooves 43 in them. The pattern of grooves 43 is converging, such that the spacing between the grooves at the entry end of the plates is larger than it is at the exit end of the plates, as shown in more detail in FIG. 5(c). Weight 44 on top of the die plates provides the means for applying pressure. The plates may be aligned by means of alignment tabs 46. The films 14 and tubes 12 are then pulled through a matching set of grooved cooling plates 48 in which the grooves are parallel. The cooling plates are cooled by means of circulating cold water supplied by chiller system 50. A weight 52 is located on top of the cooling plates in order to apply pressure to the ribbon. The belt puller 34 pulls the materials through the process to yield the ribbon. The ribbon may then optionally be slit into single tube or multiple tube structures as required.

The vacuum/thermal lamination process used in Example 1 and shown in FIGS. 4(a), 4(b) and 4(c) can be scaled up and refined, but the process does have some inherent limitations, namely:

i) The vacuum step may impose a limitation on the productivity of the process because it requires that discrete lengths be cut and placed in a vacuum chamber. The drawing of a high vacuum inside the structure appears to require a non-continuous process. A continuous process, with less handling, would be preferred.

ii) The final heat sealing step is carried out on unconstrained film so that the residual stresses in the film cause the film to shrink at or near its melting point. Since the metallic layer is unable to shrink, the result is a series of small transverse wrinkles in the finished product.

To deal with the first issue, one could conceive of a process where the ribbon is running through a zone which is subject to a continuous vacuum, but it would be necessary for the ribbon components entering the zone (and exiting the zone) to pass through some narrow opening which largely prevents air from entering the enclosure, otherwise the effect of the vacuum would be diminished. For at least some of the intended applications, i.e. those involving refrigerants under pressure, it is desirable to achieve a fully bonded structure, in order to prevent pockets of pressurized refrigerant from forming between the tubes and the film layers. This requires that essentially all of the air between the film layers and the tubes must be removed during the manufacturing process. Instead of the air being withdrawn by a vacuum, the air could be squeezed out by externally applied pressure. It is theoretically possible to achieve this by applying fluid jets to the outside of the ribbon structure.

Another, perhaps more conventional, way of pushing out the air, would be to squeeze the structure between two nip rolls. It is known in the art that film layers can be laminated by nipping them between a metal roll and a rubber roll. The complication here is the non-uniform cross-sectional shape of the ribbon.

A rubber-coated roller, of uniform cross-section, when pressed against the ribbon, does not apply the appropriate pressure at the locations immediately adjacent to a tube. The same is true if a fluid-filled bladder is used as the nip roll.

Before constructing shaped rollers, it was considered prudent to experiment with the squeezing of the ribbon structure between two grooved plates. Initial testing with matching metal plates resulted in samples in which the metallic layer was damaged. It also appeared that there was an inability to apply uniform pressure, as the metal plates were quite rigid. It was later demonstrated that precise machining of these plates alleviates or avoids these problems.

Positive results were obtained when a matching set of grooved plates, one of which was metal and the other was rubber, backed by metal, were used to clamp the film layers and tubes together. It is possible, under the right conditions, to squeeze out all of the air between the tubes and the film layers & fully bond the layers together without tearing the metallic layer & without generating many wrinkles.

The next step was to construct a grooved rubber nip roll and press it against the ribbon which lay in a series of grooves in a metal plate, with the metal plate being heated in order to form a melt-bond between the layers. An initial demonstration of the feasibility of this approach has been made. A continuous process has also been demonstrated, in which a single tube structure was squeezed and bonded between a grooved, PTFE coated, heated metal plate and a grooved, rubber nip roll. A set of rollers may also be coordinated to press the foils around the tube.

There are a number of variations and improvements on this basic approach.

a) The foils may be conformed to the tube by pressing the foils against each other in the regions exterior to the tube. Therefore, there may not need to be any direct squeezing of the tubes. The outer surface of the roller or plate, in pushing the film down into the gap between adjacent tubes, may tend to pull the film tight over the tube. Thus, it may not be necessary to contour the grooves to match the circular shape of the tubes. It may be desirable not to squeeze too hard on the plastic tubing, as it may distort or even collapse under excessive pressure, especially if hot.

b) One roller or plate could have shaped grooves which contact the ribbon and the other could have deep grooves described under item (a) above.

c) The hardness or thickness of the material used to promote contact may be varied.

One issue is in tracking the film into a structure of narrower width, since the width of the film is narrower after the film has been fully conformed to the tubes. There are some possible approaches for dealing with this.

a) It may be possible to track the film into the grooves in the roller by contacting the film to the roller prior to the nip point.

b) The film temperature could be raised to some intermediate temperature (below the melting point) just prior to the squeezing process, to make the film more conformable by lowering the flexural modulus.

c) The film layers and tubes could be contacted between a first set of grooved rollers (or plates) which squeeze out the air and conform the film around the tubes, followed by a second set of rollers (or plates) that apply heat and bond the structure together.

d) The film layers and tubes could be contacted between a first set of grooved heated rollers (or plates) which tack the tubes in position on the film layers, followed by a second set of grooved, heated rollers (or plates), in which the grooves are closer together, which completes the squeezing and bonding of the structure.

In pursuing the approach described in (d) above, some practical difficulties were encountered in tracking the films and tubes between the two sets of grooved plates with different groove-to-groove spacings. To alleviate this issue, a set of plates was constructed with converging grooves. The converging grooves were of the same size but were spaced closer together at the exit end than they were at the entrance end of the plates. The use of plates with converging grooves resulted in a successful alternative process which is described in Example 2 and illustrated in FIGS. 5(a), 5(b) and 5(c).

In accordance with the above,

i) the film and tubes could all be brought together and squeezed, then heated, and/or

ii) they could be gently squeezed and heated, then further squeezed and heated (with grooves closer together).

It will be understood by those having skill in the art to which the invention pertains, that various methods may be used to apply heat either directly or indirectly and to make the thermal lamination.

In the alternatives given above, the tubes and film are thermally bonded together as a lamination, in which the outer layer of the tubing is melt-bonded to the inner layer of the film. A somewhat related process would be an extrusion lamination, where a molten polymer is applied to (for example) the two film surfaces and then the structure is nipped together.

Another alternative would be to use a thermoset adhesive to bond the tubing to the film layers, an additional station would be added to coat the layers with the thermoset. A nipping operation would still be required, and in some cases heat would be beneficial, but the amount of heat required vs. the thermal lamination approach would be lower.

### EXAMPLES

### Example 1

Tubing with an inside diameter of 2.9 mm (0.114 inches) and a wall thickness of 0.34 mm (0.0133 inches) was used to make a ribbon structure by bonding the tubing to two film layers. The tubing was a co-extruded structure in which the inner layer consisted of nylon 66 at 0.30 mm (0.0118 inches thick) and the outer layer consisted of an anhydride-modified low density polyethylene 0.04 mm (0.0015 inches) thick, available from E. I. DuPont de Nemours & Co. as Bynel® 4206. The melting point of the polymer in the outer layer was approximately 102° C., its melt index was 2.5 and its density was 0.92 g/cc. The purpose of the outer layer was to improve the bond between the tubing and the film in the finished structure. Eight tubes of the above composition were tacked to the polyethylene surface layer of BFW-48 film from Ludlow Corporation. The BFW-48 film consists of (in order) approximately 0.038 mm (0.0015 inches) of LLDPE (linear low density polyethylene), 0.022 mm (0.00085 inches) of LDPE (low density polyethylene), 0.007 mm (0.00029 inches) of aluminum foil, 0.022 mm (0.00085 inches) of LDPE and 0.012 mm (0.00048 inches) of PET (polyethylene terephthalate), for a total thickness of approximately 0.10 mm (0.004 inches).

The tubes were tacked to the film by pulling them through a slotted tube guide and then pressing them to the surface of the film. The tubes were spaced apart, i.e. one tube did not contact the adjacent tubes in the structure. The film was heated from underneath by a “Dataplate Digital Hot Plate” made by Cole-Parmer and its surface was maintained at a uniform temperature of about 125° C. A second layer of BFW-48 film was placed facing the first layer (which had the tubes attached), such that the two polyethylene surfaces of the film were facing each other. Each film was 127 mm (5 inches) wide. The film edges were then sealed together using a “DOBOY Hospital Sealer” (a continuous rotary heat sealer). Lengths of this sleeve were produced which were approximately 100 cm (3.3 feet long). Short lengths of tubing were peeled back and cut off at each end, in order to a low the next step to proceed.

The sleeves thus formed were then placed in an AUDIONVAC AE401 vacuum sealer. The air between the film layers and the tubes was evacuated and the ends of the sleeve were sealed. The vacuum-sealed sleeves were then placed in a Blue M oven (model OV-490A-3) and heated at 120° C. for 15 minutes. The heat melted the polyethylene layers and bonded the structure together. The outside excess edges of the ribbon were trimmed. Samples of the ribbon were tested as a refrigerant hose and also, other samples of the ribbon were slit into individual tubes and tested as a refrigerant hose.

### Example 2

Tubing with an inside diameter of 1.55 mm (0.061 inches) and a wall thickness of 0.23 mm (0.009 inches) was used to make a ribbon structure by bonding the tubing to two film layers. The tubing was a co-extruded structure in which the inner layer consisted of nylon 66 at 0.19 mm (0.007 inches thick) and the outer layer consisted of an anhydride-modified low density polyethylene 0.04 mm (0.0015 inches) thick, available from E. I. DuPont de Nemours & Co. as Bynel® 4206. The melting point of the polymer in the outer layer was approximately 102° C., its melt index was 2.5 and its density was 0.92 g/cc. The purpose of the outer layer was to improve the bond between the tubing and the film in the finished ribbon structure. Ten tubes of the above composition were simultaneously bonded to two layers of BFW-48 film from Ludlow Corporation. The BFW-48 film consists of (in order) approximately 0.038 mm (0.0015 inches) of LLDPE (linear low density polyethylene), 0.022 mm (0.00085 inches) of LDPE (low density polyethylene), 0.007 mm (0.00029 inches) of aluminum foil, 0.022 mm (0.00085 inches) of LDPE and 0.012 mm (0.00048 inches) of PET (polyethylene terephthalate), for a total thickness of approximately 0.10 mm (0.004 inches).

The 10 tubes and 2 films were pulled between a pair of grooved aluminum plates, approximately 178 mm (7 inches) long. Each plate had 10 semicircular grooves running along its length, the width of each groove was 2.3 mm (0.090 inches). The plates faced each other and the order of material position was: bottom plate, bottom film, tubes, top film, top plate. The grooves in the plates were not parallel but they were straight. At the inlet end of the plates the grooves had a (center to center) spacing of 6.52 mm (0.2567 inches) and at the outlet end of the plates the center to center spacing was 5.94 mm (0.2338 inches). The plates were heated and maintained at a temperature of 145° C. A weight of 5 kg (11 pounds) was on top of the top plate, in order to provide pressure. The heat melted the polyethylene layers on the tubing and the film, causing them to bond together.

The films and tubes then passed through a matching set of grooved plates, similar to the above, except that the grooves were parallel and were 5.94 mm (0.2338 inches) apart (center to center) along their entire length. The cooling plates were in contact with hollow metal plates through which cooling water (of inlet temperature 12° C.) was circulated at 2 litres per minute. A small weight of 3.5 kg (7.7 pounds) was located on the uppermost plate in order to press on the materials passing through the plates. All 4 of the grooved plates were covered with PTFE (approximately 0.003 inches thick) in order to minimize friction. The film and tubes were pulled at a uniform speed of 21 cm (0.7 feet) per minute with a Killion model 4-24 belt puller and the edges were trimmed. The resulting structure was a ribbon which had fewer wrinkles than the samples made by Example 1, and which could be made in very long lengths, limited only by the size of the film supply rolls and tubing supply spools.

What is claimed is:

1. A method for making a fluid handling apparatus comprising at least one polymeric tube, said tube surrounded by and sealed to a laminated foil, said foil having two faces, one facing toward the tube, and the other facing away from the tube, said foil comprising at least one layer of metal with polymer layers on at least the side facing the tubes,
said tube having an inner diameter in the range of 0.5-50 mm and a wall thickness in the range of 0.1-1.0 mm,
said foil having a total thickness in the range of 0.05-0.25 mm and a metal thickness in the range of 0.0020-0.1 mm,
said method comprising the steps of
contacting the tubes on one side with a first foil,
contacting the tubes on the other side of the tubes with a second foil,
heating the tubes with the foil on at least one side to adhere the foil to the tubes before or after contacting the tubes with said second foil, conforming said first and second foils to the tubes to essentially eliminate air bubbles or gaps, and optionally completing the heat sealing of both the first and second foils to the tubes with a second heating step.

2. The method of claim 1 for making a structure having multiple tubes arranged in parallel, said tubes being held in place by, surrounded by and sealed to said laminated foil.

3. The method of claim 2 wherein individual tubes are separated from the multiple-tube structure after it is produced by slitting the foil between the tubes.

4. The method of claim 1 wherein the conforming of the foils to the tube is done by vacuum.

5. The method of claim 1 wherein the conforming of the foils to the tube is done by sliding the tubes and foils through matching grooves in plates on both sides of the tubes.

6. The method of claim 1 wherein the conforming of the foils to the tube is done by pressing the foils against each other in regions exterior to the tube.

7. The method of claim 1 wherein the conforming of the foils to the tube is done by rollers pressing the foils around the tube.

8. The method of claim 1 wherein said at least one tube further comprises a plurality of layers of polymer.

9. The method of claim 1 wherein the polymer of at least one layer of the foil facing away from the tube is polyamide.

10. The method of claim 8 wherein the polymer on the outer layer of the tube is bondable with the polymer layer of the foil facing the tube.

11. The method of claim 10 wherein at least one layer of polymer of the tube and at least one layer of the polymer of the foil are both polyamide.

12. The method of claim 1 wherein the thickness of foil is in the range of 0.07-0.2 mm and the thickness of the metal is in the range of 0.005-0.02 mm.

13. The method of claim 12 where in the thickness of the foil is in the range of 0.1-0.15 mm and the thickness of the metal is in the range of 0.005-0.01 mm.

14. The method of claim 1 wherein the inner diameter of the tube is in the range of 1-25 mm and the wall thickness of the tubes is in the range of 0.1-0.5 mm.

15. The method of claim 1 wherein the metal is aluminum.

16. The method of claim 1 wherein the foil has a layer of polyolefin on the side facing the tubes and a layer of polyamide on the side of the foil facing away from the tubes.

17. The method of claim 1 wherein the foil has no layer of polymer on the side facing away from the tubes.

18. The method of claim 1 wherein there are multiple layers of polymer in the foil.

19. A structure made by the process of claim 1 wherein there are no significant air gaps or voids between the foil and the tubes.
